(19) United States
(12) Patent Application Publication
(10) Pub. No.: US 2016/0001802 A1
(43) Pub. Date: Jan. 7, 2016

(54) RAIL VEHICLE HAVING AT LEAST ONE TRAIN PROTECTION DEVICE ACCORDING TO A NATIONAL STANDARD AND HAVING AN ETCS VEHICLE APPARATUS AND METHOD FOR OPERATING THE RAIL VEHICLE

(71) Applicant: SIEMENS AKTIENGESELLSCHAFT, München (DE)

(72) Inventor: FRANK SIMON, CREMLINGEN (DE)

(73) Assignee: SIEMENS AKTIENGESELLSCHAFT, MUENCHEN (DE)

(21) Appl. No.: 14/769,543

(22) PCT Filed: Feb. 14, 2014
(86) PCT No.: PCT/EP2014/052898

§ 371 Date: Aug. 21, 2015

(30) Foreign Application Priority Data
Feb. 26, 2013 (DE) 10 2013 203 152.1

(51) Int. Cl. B61L 15/00; G06F 13/42

(52) U.S. Cl. CPC B61L 15/0081; B61L 15/0072; B61L 15/009; G06F 13/4282

(57) ABSTRACT

A rail vehicle includes at least one train protection device according to a national standard, an ETCS vehicle apparatus with a driver's cab display, and an interface for inputting operational data via the interface for the at least one train protection device. In order to make such a rail vehicle maintenance-friendly, the train protection device is embodied in such a way that an interrogation of an identification code is generated on the driver's cab display within the scope of the inputting of the operational data, and when the response to the interrogation is correct a data interrogation with technical maintenance data is generated on the driver's cab display. A method for operating the rail vehicle is also provided.

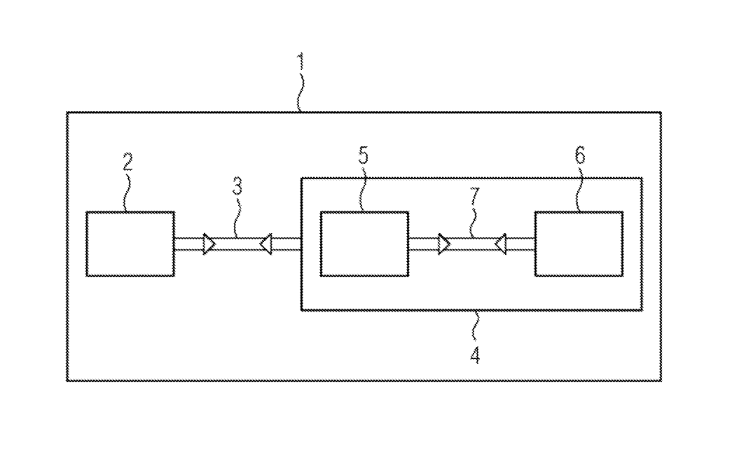

It is known for rail vehicles in the past to have been equipped almost exclusively with train protection devices conforming to a national standard in each case. In Europe, this is for example the Linienzugbeeinflussung (continuous train control) system and the various versions of PZB/Indusi train control. Furthermore, it is known that a so-called European Train Control System (ETCS), having an ETCS vehicle apparatus, has been developed for several years and has now been partially introduced. This apparatus contains inter alia an ETCS computer EVC (European Vital Computer) and a cab display DMI (Driver Machine Interface).

The invention relates to a rail vehicle having at least one train protection device according to a national standard and having an ETCS vehicle apparatus with a cab display with an interface for the input of operational data via the interface for the at least one train protection device.

In order to design a rail vehicle of this type in an easy to maintain manner, according to the invention the ETCS vehicle apparatus is embodied such that it generates a request for an identification code during the input of the operational data and, if the request is responded to correctly, a data request with maintenance data is produced on the cab display (6).

A significant advantage of the inventive rail vehicle consists in that, with such a vehicle, maintenance workers can set data settings on the train protection device in a simple manner, once the maintenance workers have correctly input the identification code; subsequently, settings data can then be input at the cab display. A maintenance computer for the train protection device or a specific human machine interface at the train protection device is not required.

The invention further relates to a method for operating a rail vehicle having at least one train protection device according to a national standard and an ETCS vehicle apparatus with a cab display with an interface for the input of operational data for the at least one train protection device.

In order to be able to carry out maintenance measures in a simple manner with this method, according to the invention a request for an identification code is generated during the input of the operational data and, if the request is responded to correctly, a data request with maintenance data is produced on the cab display (6).

The same advantages result from the inventive method as those mentioned above with regard to the inventive rail vehicle.

In order to further explain the invention, the FIGURE shows an exemplary embodiment of an inventive rail vehicle with the components of interest in connection with the invention.

The rail vehicle 1, shown only schematically, contains a train protection device 2 according to a national standard, which can be an LZB train protection device for example. An ETCS vehicle apparatus 4 is connected to the train protection device 2 so as to be able to communicate via an interface 3, which vehicle apparatus 4 contains inter alia an ETCS computer 5 and a cab display 6; the ETCS computer 5 and the cab display 6 are interconnected via an internal data bus 7.

The interface 3 represents an interface defined in /UNISIG Subset 026/ and /UNISIG 035/ and is set up in the case of an existing vehicle being additionally equipped with an ETCS vehicle apparatus in order for the train operator to be able to input operational data into the train protection device 2. UNISIG indicates the workgroup “Union Industry of Signalling” of the Association of the European Rail Industry.

During maintenance work the cab display 6 is used by maintenance workers in order to input maintenance data via the interface 3. To this end, during the input of operational data a request for an identification code is initially produced and this request is displayed on the cab display 6. If the correct identification code is input by the maintenance worker, a data request with maintenance data is then produced on the cab display 6. On the cab display 6 an input menu for maintenance data is thus presented, which requests the maintenance data from the maintenance worker. This enables maintenance of the train protection device or changes to settings of the train protection device to be carried out in a simple manner.

1-2. (canceled)

3. A rail vehicle, comprising:
at least one train protection device according to a national standard;
an ETCS vehicle apparatus having a cab display; and
an interface for inputting operational data through said interface for said at least one train protection device;
said at least one train protection device generating a request for an identification code during the inputting of the operational data and producing a data request with maintenance data on said cab display if the request is responded to correctly.

4. A method for operating a rail vehicle, the method comprising the following steps:
providing at least one train protection device according to a national standard, an ETCS vehicle apparatus with a cab display, and an interface for inputting operational data for the at least one train protection device;
generating a request for an identification code at the cab display during the inputting of the operational data; and
producing a data request with maintenance data on the cab display if the request is responded to correctly.
